(19) United States
(12) Patent Application Publication
(10) Pub. No.: US 2018/0150798 A1
(43) Pub. Date: May 31, 2018

(54) Systems and Methods for Distribution or Delivery of Retail Products

(71) Applicant: Wal-Mart Stores, Inc., Bentoville, AR (US)

(72) Inventors: Bruce W. Wilkinson, Rogers, AR (US); Todd D. Mattingly, Bentonville, AR (US)

(21) Appl. No.: 15/818,096

(22) Filed: Nov. 20, 2017

Related U.S. Application Data
(60) Provisional application No. 62/426,878, filed on Nov. 28, 2016.

(51) Int. Cl. G06Q 10/08; G06Q 30/06; G06Q 30/02

(52) U.S. Cl. CPC G06Q 10/08355; G06Q 10/087; G06Q 30/0205; G06Q 30/0633; G06Q 30/0202; G06Q 10/0838

(57) ABSTRACT

In some embodiments, apparatuses and methods are provided herein useful for processing shipments at a store such that products are routed to the store floor, another delivery vehicle, a packing or unpacking area, or directly to a customer. In some embodiments, a distribution system includes a delivery database, an order database, sensors configured to identify items as they are unloaded from a shipment, and a control circuit. By one approach, the control circuit creates a routing plan with placement instructions for bundles, containers, and pallets of items in the shipment based on the inventory records and the customer orders in the order database (which can be updated with new orders during transit of the shipment). Further, the control circuit is configured to receive identifying information, via the sensors, for items unloaded and send instructions to an associate unloading the bundle, container, or pallet regarding a placement location for the items.

### CROSS-REFERENCE TO RELATED APPLICATION

This application claims the benefit of U.S. Provisional Application No. 62/426,878 filed Nov. 28, 2016, which is incorporated herein by reference in its entirety.

### TECHNICAL FIELD

This invention relates generally to distribution or delivery of retail products.

### BACKGROUND

Retail shopping facilities handle numerous shipments each day that require unloading, sorting, organizing, and shelving numerous boxes, products, and/or shipments. The incoming shipments may include a number of different items received, such as, for example, in pallets, boxes, containers, bundles, bins or other configurations. Processing the incoming shipments typically requires significant time and may potential tie up valuable incoming inventory during this processing time. Thus, many retail facilities are interested in improving the processing of incoming shipments.

### BRIEF DESCRIPTION OF THE DRAWINGS

Disclosed herein are embodiments of systems, apparatuses and methods pertaining to delivery and/or distributing of retail products. This description includes drawings, wherein:

FIG. 1 is an exemplary block diagram of a system for delivering and/or distributing retail products in accordance with some embodiments.

FIG. 2 is an exemplary flow diagram of a method for delivering and/or distributing in accordance with several embodiments.

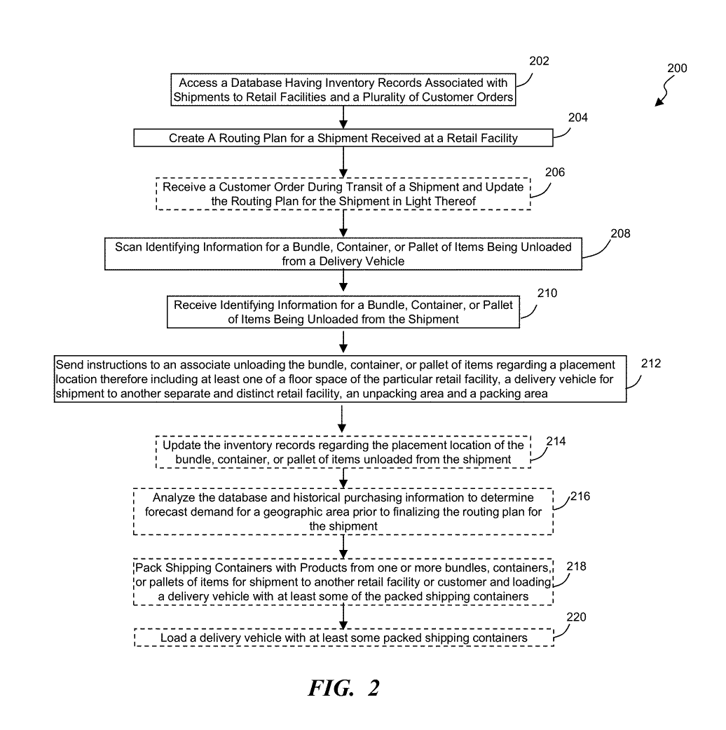

FIG. 3 illustrates an exemplary system for use in implementing systems, apparatuses, devices, methods, techniques, and the like in delivering and/or distributing retail products in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for processing shipments and/or cross-docking at a physical retail store by creating a routing plan for the bundles, containers, or pallets of items from an incoming shipment such that products may be sent to the store floor, another delivery vehicle, a packing area, an unpacking area, or directly to a customer, such as, for example, by being mailed to a customer or set aside at the retail facility for customer pick-up.

In some embodiments, a retail product distribution system for delivering products includes a delivery database having inventory records associated with shipments to retail facilities, an order database having a plurality of customer orders saved therein, sensor(s) configured to identify bundles, containers, or pallets of items as they are unloaded from a shipment received at a retail facility, and a control circuit in communication with the delivery and order databases. By one approach, the control circuit is configured to create a routing plan for a particular shipment received at a particular retail facility (i.e., store) with placement or cross-docking instructions for each of the bundles, containers, and pallets of items unloaded from the particular shipment based on the inventory records and the plurality of orders in the database. In such a configuration, the control circuit is further configured to receive identifying information, via the sensor(s), for a particular one of the bundles, containers, or pallets of items being unloaded from the particular shipment at the particular retail facility and send instructions to an associate unloading the particular one of the bundles, containers, or pallets of items regarding a placement location for the bundle, container, or pallet of items unloaded from the particular shipment As used herein, the placement location may be selected from any of the following a floor space of the particular retail facility, a delivery vehicle for shipment to another separate and distinct retail facility, an unpacking area, and a packing area. The placement location also may include a customer service area accessible by customers for fulfillment of orders in the order database.

In this manner, the physical retail facility may be a first retail store where a shipment is unloaded and/or cross-docked so that some of the products or items are unloaded and processed with an eye toward further distributing a portion of these to another, second retail store, directly to customers, or to be placed on the store floor of the first retail store (i.e., such that the items on the store floor enter the store's inventory). To do that, in one example, the system identifies products (intended for delivery to multiple retail stores and customers) to be grouped together and shipped from a distribution center. In this manner, the retail stores and customers within a particular geographic area, located along a distribution route, or another designation may be grouped together in a shipment from a distribution center. At the distribution center, the system may determine a loading sequence for the bundles, containers, or pallets of items intended for the multiple stores and customers. The system also prepares an unloading or routing plan and cross-docking or placement instructions for the receiving store (though the routing plan may be reconfigured during and after shipment as described below).

Further, when the shipment is received at the at the first retail store, the store associates will unload the shipment or delivery vehicle according to the placement or cross-docking instructions and organize products according to those instructions. In some configurations, this may include breaking one or more bundles, containers or pallets of items into cases and/or individual products. This is based on their intended final destination (i.e., second retail store, third retail store, customer's delivery address, delivery locker, customer pick-up at the first retail store, store floor of the first retail store, etc.) and is captured in the instructions to the store associates unloading and processing the bundles, containers, or pallets unloaded from the shipment. As used herein, a product's final destination is the last location that the retail product distribution system 100 may deposit the items, and accordingly, does not include locations outside the system where customers may subsequently take or place the products.

In some embodiments, the placement or cross-docking instructions, such as at an unpacking and/or packing area in the first retail store, may include combining products from an earlier shipment (i.e., delivery vehicle) with products from one or more subsequent shipments to complete a delivery load intended for a second retail store or a customer. In one configuration, the routing plan or cross-docking instructions may contemplate further subsequent cross-docking at one or more subsequent retail stores (e.g., second retail store or third retail stores) such that, for example, cross docking at the second retail store may have products forwarded to a third retail store or directly to customers. Some advantages of this approach are the ability to reduce shipping cost, generate cost reductions by purchasing and shipping larger quantities of a particular product, and reroute products based on customer orders. For example, an entire pallet of product may be shipped to a first retail store, even though that single store does not need an entire pallet, but the product may be intended for multiple stores, but then some of that product may be re-routed in light of forecast customer demand and/or customer orders.

As suggested above, the final destination for the products may not be determined until the shipment has left the distribution center or the previous retail store. Instead, the decision about where to route the items in the bundles, containers, or pallets may be made when the items are being unloaded and just before instructions regarding placement thereof are being made. Thus, if the system receives a customer's orders after a shipment has been sent to a retail store such that the order database is updated during transit of the shipment to the retail facility, the control circuit may update the routing plan for the bundles, container, or pallets of items in the particular shipment during transit or arrival of the shipment at the retail facility in light of the customer orders received during transit.

To facilitate, ease of processing, the system may include identification tags on items unloaded from the shipment or delivery vehicle. More particularly, the system may include identification tags associated with some of the bundles, containers, or pallets of items that the sensor(s) read during unloading of the associated bundles, containers, or pallets of items. In this manner, in response to receipt of an identifier associated with the identification tag or information regarding a particular identification tag, the control circuit may send instructions regarding placement of a particular bundle, container, or pallet of items associated with the particular identification tag.

In another aspect, to facilitate ease of unloading the shipment, in some embodiments, the system includes a conveyor configured to receive at least one of the bundles, containers, or pallets of items from the shipment. Further, the control circuit, in such a configuration, instruct the associate unloading one of the bundles, containers or pallets of items from the conveyor regarding the placement location for the bundle, container, or pallet of items upon removal thereof from the conveyor.

As noted above, once unloaded from the shipment, the bundles, container, or pallets of items and the products therein may be destined for a number of different locations, in or outside of the retail store where received. By one approach, some of the bundles, containers, or pallets of items that are removed from a delivery vehicle are placed into an unpacking area in the retail facility. Accordingly, the control circuit is configured to update placement location of a particular bundle, container, or pallet of items after arrival thereof in the unpacking area. At this location, the associate may unwrap and de-palletize items. As suggested above, in this or an adjacent packing area, the products or items from the bundles, containers, or pallets of items may be organized or repackaged into other containers or boxes for shipment to customers or other retail stores. For example, in one approach, the packing area is configured for packaging portions of at least one of the bundle, container or pallet of items into containers for shipment to at least one of the separate and distinct retail facility or another customer.

As suggested above, the routing instructions for an item or a final destination for an item may be updated during transit of a shipment. To determine where a bundle, container, or pallet of items (or the products therein) should be routed, the control circuit, in some configurations, analyzes the delivery database and the order database to determine actual demand for a geographic area. This information may then be considered when developing or creating a routing plan for the items in a shipment. Similarly, the control circuit, in some configurations, analyzes the delivery database, the order database, and historical purchasing information to determine forecast demand for a geographic area, which may be considered when developing or creating a routing plan for items in a shipment. To assist with the analysis, in some configurations, the order database further includes retail store stock levels indicating stocking needs.

In one embodiment, real-time adjustments may be made to the routing plan or instructions by having up-to-date information on the locations of the shipments and parts thereof. To that end, the control circuit may update an inventory record of the delivery database regarding a received location of the bundle, container, or pallet of items unloaded from the particular shipment.

In one illustrative embodiment, the retail distribution system also includes electronic user devices, in communication with the control circuit, configured to be accessible by an associate user unloading the shipments at the retail facilities. In this manner, the electronic user devices receive a routing plan from the control circuit and provide instructions to the user regarding the unloading of the particular one of the bundles, containers, or pallets of items being unloaded from the shipment according to the routing plan. Further, in another embodiment, the electronic user devices create an updated routing plan based on movement of the bundles, containers, or pallets of items or updated information in at least one of the delivery database or the order database. In this manner, the updated routing plan is created locally based on information in the control circuit, but which may be modified by information that is acquired on the ground as the shipment is unloaded. In this manner, by spreading out intelligence and updating accordingly, the shipment can be processed in a faster, more efficient manner.

By one approach, the routing plan may take customer demand or store needs into account. For example, if the retail facility is particularly low on a product that is in high demand, the unloading and placement instructions (e.g., the routing plan for the shipment) may be modified to expedite unloading and processing of the particular bundle, container, or pallet of items where the product is located. For example, the particular bundle, container, or pallet of items containing the high demand product may be unloaded and processed before the remaining parts of the shipment (this may be the approach particularly where the distribution center or previous retail facility where the shipment was sent from has notice of the need and can place the items in an easily accessible location on the vehicle). By another example, the unloading and placement instructions may be modified to facilitate removal of the bundles, containers, or pallets of items blocking access to the particular high demand product without unpacking or otherwise processing the blocking bundles, containers, or pallets of items such that the associates unloading the vehicle proceed directly to the bundles, containers, or pallets of items containing the high demand product and begin processing or moving that bundle, container, or pallet of item accordingly.

In some embodiments, a method for distributing retail products includes accessing a database with inventory records associated with shipments (having bundles, containers, or pallets of items therein) to retail facilities and a plurality of customer orders, creating a routing plan for a particular shipment to be received at a retail facility with placement or cross-docking instructions for each of the bundles, containers, and pallets of items unloaded from the shipment based on the inventory records and the plurality of orders in the database, scanning identifying information for the bundles, containers, or pallets of items unloaded from a delivery vehicle, and sending instructions to an associate unloading the bundles, containers, or pallets of items being unloaded regarding a placement location for the bundles, containers or pallets of items (the placement location including at least one of a floor space of the particular retail facility, a delivery vehicle for shipment to another separate and distinct retail facility, and a packing area). Further, the method may include, for some of the items or products unloaded from the shipment, packing shipping containers with products from one or more of the bundles, containers, or pallets of items for shipment to at least one of another retail facility or a customer based on item destinations in the database and loading a delivery vehicle with at least some of the packed shipping containers.

In yet another configuration, a retail product distribution and delivery system for managing product distribution includes a shopping user interface for receiving customer orders, an order database with customer orders saved therein, a delivery database having inventory records associated with shipments to a retail facility, sensor(s) configured to identify the bundles, containers, or pallets of items unloaded from the shipments received at the retail facility, and a control circuit in communication with the delivery and order databases. In one such configuration, the control circuit receives customer orders during transit of a particular shipment from a distribution center, receives identifying information, via the one or more sensors at the particular retail facility (after receipt of the shipment), for a particular one of the bundles, containers, or pallets of items being unloaded from the particular shipment at the particular retail facility, and sends instructions regarding a placement location of at least a portion of the particular one of the bundles, containers, or pallets of items unloaded from the shipment based, at least in part, on an updated order database having received at least one customer order during transport of the particular shipment. In addition, the control circuit in such an approach, updates the inventory record of the delivery database regarding the placement location of the particular one of the bundles, containers, or pallets of items unloaded from the particular shipment. In this manner, such a retail product distribution system permits mid-transit (in real-time) decisions to be made (and updated) regarding the destination for products or items in the shipment. To that end, the instructions received by the associate at the retail store are updated accordingly, as are the destinations in the databases accessed by the control circuit, based on the updated needs or customer orders database.

Based on the information in the databases, the control circuit may create a routing plan for the particular shipment in real-time such that the placement or cross-docking instructions for each of the bundles, containers, and pallets of items unloaded from the particular shipment are set as the particular bundle, container, or pallet of items is unloaded from the shipment.

As mentioned above, the bundle, container or pallet placement location may include a floor space of the particular retail facility, a delivery vehicle for shipment to another separate and distinct retail facility, a packing area, a particular customer for fulfillment of a particular order in the order database, a packing area, and/or an unpacking area. Similar to previous embodiments discussed, such a retail product distribution system may employ identification tags on bundles, containers, or pallets of items and a conveyor to assist with unloading of the shipment. Also, the control circuit may analyze the delivery database and the order database to determine actual demand for a geographic area or analyze the delivery database, the order database, and historical purchasing information to determine forecast demand for a geographic area. In addition, the order database may include retail store stock levels indicating stock or restocking needs.

In some embodiments, a method for distributing retail products includes accessing a database with inventory records associated with shipments (bundles, containers, or pallets of items therein), receiving customer order(s) during transit of a shipment from a distribution center to a retail facility, receive identifying information (from the retail facility) for a bundle, container, or pallet of items being unloaded from a delivery vehicle, sending instructions to an associate unloading the bundle, container, or pallet of items being unloaded regarding a placement location for the bundles, containers or pallets of items being unloaded from the delivery vehicle based, in part, on an updated order database having received at least one customer order during transport of the particular shipment, and updating the inventory record of the database regarding the placement location of the particular one of the bundles, containers, or pallets of items unloaded from the particular shipment. By one approach, the method includes creating a routing plan for the particular shipment received with placement or cross-docking instructions for the bundles, containers, and pallets of items unloaded from the particular shipment based on the inventory records and the plurality of orders in the database.

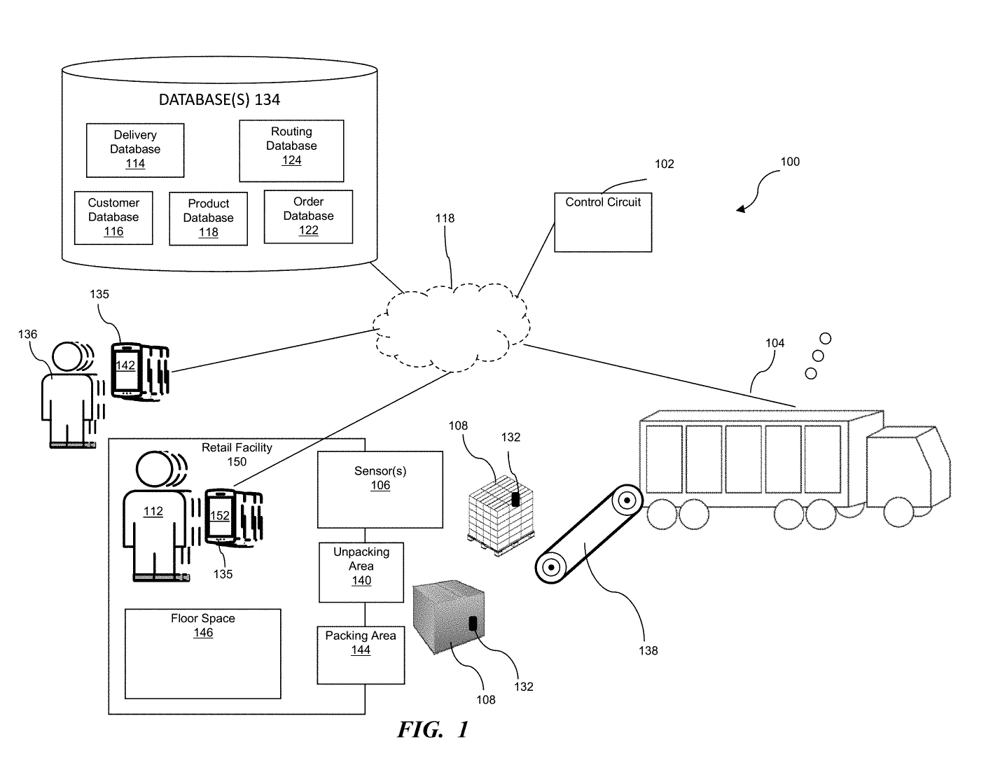

FIG. 1 illustrates a retail product distribution system 100 for distributing products in shipments on delivery vehicles 104 to retail facilities 150. By one approach, the system 100 includes a delivery database 114 having inventory records stored therein and an order database 122 with customer orders stored therein. According to one configuration, a shipment to a retail facility may have inventory records associated therewith. By another approach, the system 100 may include a customer database 116, a product database 118, and/or a routing database 124. The system 100 also includes a control circuit 102 in communication with the one or more databases 134 over a network 118.

The control circuit 102 may have a number of different configurations as outlined below. In one configuration of the retail product distribution system 100, the control circuit 102 creates a routing plan (which may be stored in the routing database 124) for a shipment that is received (or scheduled for receipt) at a particular retail facility. The routing plan in the routing database 124 typically includes placement or cross-docking instructions for the bundles, containers, and pallets of items 108 unloaded (or to be unloaded) from the particular shipment based, at least in part, on the inventor records in the delivery database 114 and the plurality of orders in the database 122. In one illustrative configuration, the routing plan may be initially created just before or during shipment of a particular delivery and then may be updated later during transport of the shipment, upon receipt of the shipment at a retail facility, or during the unloading process of the shipment.

The system 100 also includes one or more sensors 106 configured to identify the bundles, containers, or pallets of items 108 unloaded from shipments received at the retail facilities 150. The sensors 106 may be a variety of sensors such as, for example, an optical sensor, a digital camera, and/or an RFID tag reader, among others. By one approach, the sensors 106 include an optical sensor configured to scan product codes on the retail items at the retail facility 150 as the items bundle, container, or pallet are being removed from the truck or into the retail facility, such as, for example, into an unpacking area 140. Further, the optical sensor also may capture electronic images of the bundles, container, or pallets of items such that the control circuit may analyze the captured electronic image or store the captured image in the database. The bundle, container, or pallet sensor 106 may have a variety of configurations, and may employ, for example, RFID communications, cellular communications, Wi-Fi communications, or combinations thereof. By one approach, the sensors 106 are mounted at or near the entrance(s) or exit(s) of the delivery vehicle 104. By another approach, the sensors 106 may be carried by or mounted to the associates unloading the delivery vehicle 104. For example, in one illustrative approach, the sensor 106 (whether mounted onto the associate, delivery vehicle, or other equipment) is in communication the electronic user devices 135 carried by the associates unloading the delivery vehicle 104 such that the electronic user devices 135 provide instructions to the associate regarding the placement location of the items being unloaded after the sensors 106 have identified the particular bundle, container, or pallet of items that the associate is unloading.

As mentioned above, the system may employ identification tags, such as tags 132. In one configuration, at least some of the bundles, containers, or pallets have identification tags 132 (such as, for example, RFID tags) associated therewith that can be readily detected or read by the sensors 106. For example, the identification tags are read by the sensors 106 during unloading of the associated bundle, container, or pallet of items. Further, in response to detection of the particular bundle, container, or pallet that is identified by the sensor 106, the control circuit 102 can review the databases 134 and a routing plan or list of instructions to determine where the particular bundle, container, or pallet should be directed and the control circuit may send instructions regarding placement of the particular bundle, container, or pallet of items with the identification tag to the store associate assisting with unloading of the shipment, via the electronic user device 135 associated with that store associate.

As noted above, the control circuit 102 creates a routing plan. Further, the control circuit 102 receives identifying information from the sensor(s) 106 for one of the bundles, containers, or pallets of items being unloaded from the shipment at the retail facility and sends instructions to an associate 112 unloading the particular one of the bundles, containers, or pallets of items regarding a placement location for the bundle, container, or pallet of items being unloaded from the shipment (such as via an electronic user device 135). As noted above, the placement location may include, for example, a floor space 146 of the retail facility 150 receiving the shipment, another delivery vehicle 104 for shipment to another separate and distinct retail facility, a packing area 144, an unpacking area 140, and/or a customer service area (such as for retrieval by a customer). By one approach, the customer service area is accessible by a particular customer such that the customer can fulfill a particular order (or portion thereof) in the order database.

The retail orders or the bundle, container, and pallet identifiers, for example, may be provided to a central computer, server, or the control circuit 102 either directly or indirectly, such as through a network 118. In some configurations, the network 118 also may communicate information to or from one of the databases 134. As illustrated in FIG. 1, the control circuit 102, the electronic user devices 135, the shopping user interface 142, or the associate user interface 152, and/or the database(s) 134, if present, may be communicatively coupled, either directly or indirectly, such as over one or more distributed communication networks 118, which may include, for example, LAN, WAN, Internet, cellular, Wi-Fi, and other such communication networks or combinations of two or more of such networks.

By one approach, the system 100 includes a shopping user interface 142 that may be displayed or operated on or by one or more electronic user device 135 of one or more customers 136. In this manner, the customers 136 may submit retail orders for products. In one configuration, the products may be delivered directly to the customer. In another configuration, the products may be retrieved at a retail store. Further, the shopping user interface may be executed within or on the electronic user devices 135 of the customers 136. The shopping user interface 142 may be provided to the electronic user devices 135 by the control circuit 102 or may be configured to be executed by the electronic user devices 135 when in communication with the control circuit 102.

If the shopping user interface 142 is used to submit an order (such as by a customer 136 via an electronic user device 135) during transit of a particular shipment, the shipment (or, more particularly, a portion thereof) may be used to fulfill the order submitted during transit of the shipment. In this manner, the order database 122 is updated during transit of the shipment to the retail facility 150 and the control circuit 102 updates the routing plan for the particular shipment (by, for example, noting instructions for movement of a particular item or product in the shipment) during transit or arrival of the shipment at the retail facility.

After arrival of the delivery vehicle 104 (i.e., the shipment) at the retail facility 150, the store associates 112 unload the bundles, containers, or pallets thereon. In one illustrative approach, the system 100 includes a conveyor 138 to assist in the unloading process. For example, the conveyor 138 may receive a bundle, container, or pallet of items from the shipment and move the bundle, container, or pallet of items from the vehicle 104 to a location outside or farther away from the delivery vehicle 104. Further, the control circuit 102, by one approach, is configured to instruct the associate 112 (via an electronic user device 135) unloading one of the bundles, containers, or pallets of items from the conveyor regarding the placement location of the bundle, container, or item upon removal thereof from the conveyor 138.

As noted above, the placement location may be selected from any of the following: a floor space of the particular retail facility, a delivery vehicle for shipment to another separate and distinct retail facility, an unpacking area, a packing area, and a customer service area. A single bundle, container, or pallet may have items with different destinations but generally, the bundle, container, or pallet has a single placement location where the group of items are to be placed after removal from the delivery vehicle 104. In many such configurations where the items in a single grouping have a variety of destinations, the initial placement location is an unpacking area 140 that permits one of the store associates 112 to unwrap and de-palletize or disassociate the various items and route them to a second placement location or destination. More particularly, in some configurations, at least some of the bundles, containers, or pallets of items that are removed from a delivery vehicle 104 are placed into an unpacking area 140 in the retail facility 150 and the control circuit 102 update may update or confirm the placement location after arrival thereof in the unpacking area.

For items or products headed directly to customers from the retail facility (without being placed into inventory at the retail facility 150), the items or products from the shipment may be packaged at a packing area 144. By one approach, the packing area 144 is configured to permit associates to readily package a portion of a bundle, container, or pallet of items (possibly along with other items) into containers for shipment to at least one of separate and distinct retail facilities or a customer.

Dynamic product or stock allocations, which can be updated based on a number of factors, are provided by having information on the customer needs, but also by tracking the items as they move from the vendors, distribution centers, and retail facilities. By one approach, the control circuit 102 updates an inventory record of the delivery database 114 regarding a received location of the bundle, container, or pallet of items unloaded from the particular shipment.

As described above, the final destination for various items in a shipment may not be the retail facility receiving the shipment. Instead, items from a shipment may be directly sent to customers or to another retail facility and may never be placed into the inventory at the retail facility receiving the shipment. For example, instead of heading to the store floor of the retail facility receiving the bundles, containers, or pallets of items, the items may be directly headed for a particular customer (without entering the inventory of the retail facility) or to another retail facility. A routing plan with instructions for how the bundles, containers, or pallets of items should be handled to ensure the items are routed to the proper location is set during shipment of the delivery vehicle, but the routing plan may be updated after being initially set, and even during the unloading of the delivery vehicle. As noted above, the routing plan may be updated in light of specific customer orders. In addition, the routing plan be updated based on other concerns or circumstances, such as customer demand in an area or historical purchasing information. By one approach, the control circuit 102 is configured to analyze the delivery database and the order database to determine actual demand for a geographic area and then update the routing plan accordingly. By another approach, the control circuit 102 is configured to analyze the delivery database, the order database, and historical purchasing information to determine forecast demand for a geographic area and then update the routing plan accordingly. In such configurations, one of the databases 134, such as the order database 122, the product database 118, and/or the delivery database 114, may include retail store stock levels indicating stocking needs of one or more retail facilities.

As noted, the electronic user devices 135 assist the associates 112 in routing or moving the items or products according to the routing plan. By one approach, the electronic user devices 135 are accessible by an associate user unloading the shipments at the retail facilities and the electronic user devices 135 are configured to receive the routing plan from the control circuit 102 and provide instructions to the associate user regarding the unloading of a particular one of the bundles, containers, or pallets of items being unloaded regarding where to direct or place the bundle, container, or pallet of items according to the routing plan. By another approach, the electronic user devices 135 used by the associate user 112 unloading the shipments may create an updated routing plan based on movement of the bundles, containers, or pallets of items or updated information in at least one of the databases 134. Accordingly, in such a configuration, the electronic user device 135 may provide the updated routing plan to the control circuit 102.

The system 100 of FIG. 1 also may be employed to provide a mid-transit (or real-time) routing plan for a shipment, which may be updated as the shipment is unloaded. In this manner, the stock directions or routing instructions are based on up-to-date needs. For example, the system 100 includes a shopping user interface 142 for receiving customer orders, an order database 122 with customer orders therein, a delivery database 114 with inventory records associated with shipments to a retail facility, sensors 106 that identify the bundles, containers, or pallets of items unloaded at the retail facility, and a control circuit 102. By one approach, the control circuit receives a customer order (via the interface 142) during transit of a particular shipment, receives identifying information (via the sensors 106) as the bundles, containers, or pallets of items is unloaded from the shipment, sends instructions regarding a placement location of the bundle, container, or pallet of items unloaded (based, in part, on the updated order database having received at least one customer order during transport of the shipment), and update the inventory record of the delivery database 114 regarding the placement location of the bundle, container, or pallet of items unloaded. For example, the control circuit 102 creates a routing plan for the particular shipment in real-time such that the placement or cross-docking instructions for each of the bundles, containers, and pallets of items unloaded from the particular shipment are set as the particular bundle, container, or pallet of items is unloaded from the shipment. In this manner, a customer who ordered a home delivery of certain products (but who also lives proximate a retail facility) may receive one of the products that was headed to the nearby retail store much quicker than if the product needed to be sent to them from a vendor or distribution center. Accordingly, such a system provides significant value by decreasing the time it takes to fulfill customer orders and provides an up-to-date allocation of resources.

In one exemplary embodiment, a method 200 is provided herein for distributing retail products. By one approach, the method 200 includes accessing 202 a database with inventory records associated with shipments to retail facilities and a plurality of customer orders and creating 204 a routing plan for a shipment received or to be received at a particular retail facility with cross-docking or placement instructions for each of the bundles, containers, and pallets of items to be unloaded from the shipment based on inventory records and the orders in the database. In step 206, the method 200 may include receiving a customer order during transit of a shipment and updating the routing plan for the shipment in light thereof. In another aspect, the method 200 includes scanning 208 identifying information for one of the bundles, containers, or pallets of items unloaded from a delivery vehicle carrying the shipment and/or receiving 210 identifying information for a bundle, container, or pallet of items being unloaded. In step 212, the method sends instructions to an associate (via an electronic user device) regarding a placement location for the bundles, containers, or pallets of items unloaded form the delivery vehicle, the placement location including at least one of a floor space, a delivery vehicle for shipment to another separate and distinct retail facility, an unpacking area, and a packing area.

In another embodiment, the method 200 includes updating 214 the inventory records of the database regarding the placement location of the particular one of the bundles, containers, or pallets of items unloaded from the shipment. In step 216, the method 200 may include analyzing the database and historical purchasing information to determine forecast demand for a geographic area prior to finalizing the routing plan for the shipment and updating the routing plan for the particular shipment based on forecast demand.

In step 218, the method 200 may include packing shipping containers with products from one or more of the bundles, containers, or pallets of items for shipment to another retail facility or a customer based on item destinations (i.e., final destination) in the database. Further, in step 220, the method may include loading a delivery vehicle with at least some of the packed shipping containers.

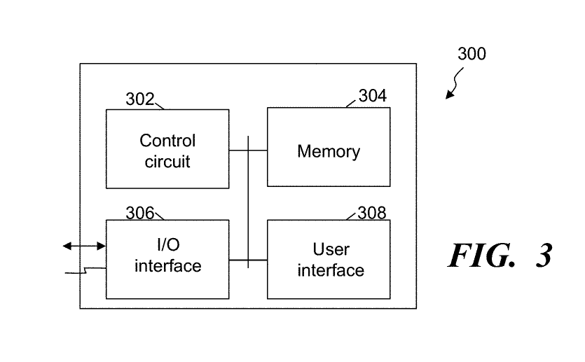

The methods, techniques, systems, devices, services, servers, sources and the like described herein may be utilized, implemented and/or run on many different types of devices and/or systems. Referring to FIG. 3, there is illustrated a system 300 that may be used for any such implementations, in accordance with some embodiments. One or more components of the system 300 may be used to implement any system, apparatus or device mentioned above, or parts of such systems, apparatuses or devices, such as for example any of the above or below mentioned control circuits, electronic user devices, sensor(s), databases, parts thereof, and the like. However, the use of the system 300 or any portion thereof is, certainly not required.

By way of example, the system 300 may include one or more control circuits 302, memory 304, input/output (I/O) interface 306, and/or user interface 308. The control circuit 302 typically comprises one or more processors and/or microprocessors. The memory 304 stores the operational code or set of instructions that is executed by the control circuit 302 and/or processor to implement the functionality of the systems and devices described herein, parts thereof, and the like. In some embodiments, the memory 304 may also store some or all of particular data that may be needed to deliver retail products outside of a retail facility.

It is understood that the control circuit 302 and/or processor may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the system 300; however, the memory 304 can be internal, external or a combination of internal and external memory. The system 300 also may include a database (not shown in FIG. 3) as internal, external, or a combination of internal and external to the system 300. Additionally, the system typically includes a power supply (not shown), which may be rechargeable, and/or it may receive power from an external source. While FIG. 3 illustrates the various components being coupled together via a bus, it is understood that the various components may actually be coupled to the control circuit 302 and/or one or more other components directly.

Generally, the control circuit 302 and/or electronic components of the system 300 can comprise fixed-purpose hard-wired platforms or can comprise a partially or wholly programmable platform. These architectural options are well known and understood in the art and require no further description here. The system and/or control circuit 302 can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 306 allows wired and/or wireless communication coupling of the system 300 to external components and/or or systems. Typically, the I/O interface 306 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 310 may be used for user input and/or output display. For example, the user interface 310 may include any known input devices, such one or more buttons, knobs, selectors, switches, keys, touch input surfaces, audio input, and/or displays, etc. Additionally, the user interface 310 include one or more output display devices, such as lights, visual indicators, display screens, etc. to convey information to a user, such as but not limited to communication information, status information, order information, delivery information, notifications, errors, conditions, and/or other such information. Similarly, the user interface 310 in some embodiments may include audio systems that can receive audio commands or requests verbally issued by a user, and/or output audio content, alerts and the like.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A retail product distribution system for delivering products comprising:
a delivery database having inventory records associated with shipments to retail facilities;
an order database having a plurality of customer orders saved therein;
one or more sensors configured to identify at least one of bundles, containers, or pallets of items unloaded from the shipments received at the retail facilities;
identification tags associated with at least some of the bundles, containers, or pallets of items that the one or more sensors read during unloading of the associated bundles, containers, or pallets of items; and
a control circuit in communication with the delivery and order databases, the control circuit configured to:
create a routing plan for a particular shipment received at a particular retail facility with placement instructions for each of the bundles, containers, and pallets of items unloaded from the particular shipment based on the inventory records and the plurality of orders in the database;
receive identifying information, via the one or more sensors, for a particular one of the bundles, containers, or pallets of items being unloaded from the particular shipment at the particular retail facility;
send instructions to an associate unloading the particular one of the bundles, containers, or pallets of items based on the identification tag associated therewith regarding a placement location for the particular one of the bundles, containers, and pallets of items unloaded from the particular shipment, the placement location being selected from any of the following a floor space of the particular retail facility, a delivery vehicle for shipment to another separate and distinct retail facility, and a packing area; and
update an inventory record of the delivery database regarding a received location of the bundle, container, or pallet of items unloaded from the particular shipment; and
one or more electronic user devices, in communication with the control circuit, configured to be accessible by a user unloading the shipments at the retail facilities, the electronic user devices configured to receive the routing plan from the control circuit and provide instructions to the user regarding the unloading of the particular one of the bundles, containers, or pallets of items being unloaded from the shipment according to the routing plan.

2. The retail product distribution system of claim 1 wherein the orders database is updated during transit of the shipment to the retail facility and the control circuit updates the routing plan for the particular shipment during transit or arrival of the shipment at the retail facility.

3. The retail product distribution system of claim 1 further comprising a conveyor configured to receive at least one of the bundles, containers, or pallets of items from the shipment and the control circuit is further configured to instruct the associate unloading one of the bundles, containers or pallets of items from the conveyor regarding the placement location for the at least one of the bundles, containers, or pallets of items upon removal thereof from the conveyor.

4. The retail product distribution system of claim 1 wherein at least some of the bundles, containers, or pallets of items that are removed from a delivery vehicle are placed into an unpacking area in the retail facility and the control circuit is further configured to update placement location of a particular bundle, container, or pallet of items after arrival thereof in the unpacking area.

5. The retail product distribution system of claim 1 wherein the control circuit is further configured to analyze the delivery database and the order database to determine actual demand for a geographic area.

6. The retail product distribution system of claim 1 wherein the control circuit is further configured to analyze the delivery database, the order database, and historical purchasing information to determine forecast demand for a geographic area.

7. The retail product distribution system of claim 1 wherein the order database further includes retail store stock levels indicating stocking needs.

8. The retail product distribution system of claim 1 wherein the packing area is configured for packaging portions of at least one of the bundle, container or pallet of items into containers for shipment to at least one of the separate and distinct retail facilities or another customer.

9. The retail distribution system of claim 1 wherein the placement location further includes a customer service area accessible by a particular customer for fulfillment of a particular order in the order database.

10. The retail distribution system of claim 1 wherein the one or more electronic user devices create an updated routing plan based on movement of the bundles, containers, or pallets of items or updated information in at least one of the delivery database or the order database.

11. A retail product distribution system for managing product distribution comprising:
a shopping user interface configured to receive customer orders;
an order database having a plurality of customer orders saved therein;
a delivery database having inventory records associated with shipments to a retail facility;
one or more sensors configured to identify at least one of bundles, containers, or pallets of items unloaded from the shipments received at the retail facility;
identification tags associated with at least some of the bundles, containers, or pallets of items that the one or more sensors read during unloading of the associated bundles, containers, or pallets of items and upon receipt of information regarding a particular identification tag, the control circuit is further configured to send instructions regarding placement of a particular bundle, container, or pallet of items associated with the particular identification tag; and
a control circuit in communication with the delivery and order databases, the control circuit is configured to:
receive one or more customer orders during transit of a particular shipment from a distribution center;
create a routing plan for the particular shipment in real-time such that the instructions for each of the bundles, containers, and pallets of items unloaded from the particular shipment are set as the particular bundle, container, or pallet of items is unloaded from the shipment;
analyze the delivery database and the order database to determine actual demand for a geographic area or analyze the delivery database, the order database, and historical purchasing information to determine forecast demand for a geographic area and update the routing plan accordingly; and upon receipt of information regarding a particular identification tag, the control circuit is further configured to send instructions regarding placement of a particular bundle, container, or pallet of items associated with the particular identification tag
upon receipt of the particular shipment at a particular retail facility and receipt of identifying information associated with a particular identification tag, via the one or more sensors, for a particular one of the bundles, containers, or pallets of items being unloaded from the particular shipment at the particular retail facility;
send instructions regarding a placement location of the particular one of the bundles, containers, or pallets of items unloaded from the shipment based, at least in part, on an updated order database having received at least one customer order during transport of the particular shipment; and
update the inventory record of the delivery database regarding the placement location of the particular one of the bundles, containers, or pallets of items unloaded from the particular shipment.

12. The retail product distribution system of claim 11 further comprising conveyor configured to receive at least one of the bundles, containers, or pallets of items from the shipment and the control circuit is further configured to instruct the associate unloading one of the bundles, containers or pallets of items from the conveyor regarding the placement location for the at least one of the bundles, containers, or pallets of items removed from the conveyor.

13. The retail product distribution system of claim 11 wherein the placement location of the at least a portion of the particular one of the bundles, containers, or pallets of items unloaded form the shipment includes at least one of a floor space of the particular retail facility, a delivery vehicle for shipment to another separate and distinct retail facility, a packing area, and a particular customer for fulfillment of a particular order in the order database.

14. The retail product distribution system of claim 13 wherein at least some of the bundles, containers, or pallets of items that are removed from a delivery vehicle are placed into an unpacking area in the retail facility and the control circuit is further configured to update placement location of a particular bundle, container, or pallet of items after arrival thereof in the unpacking area.

15. The retail product distribution system of claim 11 wherein the order database further includes retail store stock levels indicating stocking needs.

16. A method for distributing retail products, the method comprising:
accessing a database having inventory records associated with shipments to retail facilities and a plurality of customer orders, the shipments having bundles, containers, or pallets of items therein;
creating a routing plan for a particular shipment received or to be received at a particular retail facility with placement instructions for each of the bundles, containers, and pallets of items to be unloaded from the particular shipment based on the inventory records and the plurality of orders in the database;
receiving at least one customer order during transit of the particular shipment and updating the routing plan for the particular shipment in light thereof;
scanning identifying information for a particular one of the bundles, containers, or pallets of items being unloaded from a delivery vehicle;
sending instructions to an associate unloading the particular one of the bundles, containers, or pallets of items being unloaded from the delivery vehicle regarding a placement location for the particular one of the bundles, containers or pallets of items being unloaded from the delivery vehicle, the placement location including at least one of a floor space of the particular retail facility, a delivery vehicle for shipment to another separate and distinct retail facility, an unpacking area, and a packing area;
packing shipping containers with products from one or more of the bundles, containers, or pallets of items for shipment to at least one of another retail facility or a customer based on item destinations in the database; and
loading a delivery vehicle with at least some of the packed shipping containers.

17. The method of claim 16 further comprising analyzing the database and historical purchasing information to determine forecast demand for a geographic area prior to finalizing the routing plan for the particular shipment.

18. A method for distributing retail products, the method comprising:
accessing a database having inventory records associated with shipments to retail facilities and a plurality of customer orders, the shipments having bundles, containers, or pallets of items therein;
receiving one or more customer orders during transit of a particular shipment to a particular retail facility;
receive identifying information for a particular one of the bundles, containers, or pallets of items being unloaded from a delivery vehicle;
sending instructions to an associate unloading the particular one of the bundles, containers, or pallets of items being unloaded from the delivery vehicle regarding a placement location for the particular one of the bundles, containers or pallets of items being unloaded from the delivery vehicle based, in part, on an updated order database having received at least one customer order during transport of the particular shipment; and
updating the inventory records of the database regarding the placement location of the particular one of the bundles, containers, or pallets of items unloaded from the particular shipment; and
packing shipping containers with products from one or more of the bundles, containers, or pallets of items for shipment to at least one of another retail facility or a customer based on item destinations in the database; and
loading a delivery vehicle with at least some of the packed shipping containers.

19. The method of claim 18 further comprising creating a routing plan for the particular shipment received with placement instructions for each of the bundles, containers, and pallets of items to be unloaded from the particular shipment based on the inventory records and the plurality of orders in the database.

20. The method of claim 18 further comprising analyzing the database and historical purchasing information to determine forecast demand for a geographic area prior to finalizing the routing plan for the particular shipment.
